(19) United States
(12) Patent Application Publication
(10) Pub. No.: US 2026/0327141 A1
(43) Pub. Date: Oct. 22, 2026

(54) MULTIPHASE NANOCOMPOSITE MATERIAL

(71) Applicant: IMAM MOHAMMAD IBN SAUD ISLAMIC UNIVERSITY, Riyadh (SA)

(72) Inventors: Ehab Abdelhamed Abdelrahman AHMED, Riyadh (SA); Babiker yagoub Elhadi ABDULKHAIR, Riyadh (SA)

(73) Assignee: IMAM MOHAMMAD IBN SAUD ISLAMIC UNIVERSITY, Riyadh (SA)

(21) Appl. No.: 19/180,295

(22) Filed: Apr. 16, 2025

(51) Int. Cl. C04B 35/462; C04B 35/626

(52) U.S. Cl. CPC C04B 35/462; C04B 35/62645; C04B 35/62685

(57) ABSTRACT

An orthorhombic TiO₂/orthorhombic CaTiO₃/cubic CdO/tetragonal TiO₂/C nanocomposite material includes an orthorhombic titanium dioxide (TiO₂) phase, an orthorhombic calcium titanate (CaTiO₃) phase, and a cubic cadmium oxide (CdO) phase, and a tetragonal TiO₂ phase. The orthorhombic TiO₂/orthorhombic CaTiO₃/cubic CdO/tetragonal TiO₂/C nanocomposite material has a porous, granular morphology including spherical particles having an average particle diameter ranging from 10 nanometer (nm) to 140 nm. Further, a method of producing the orthorhombic TiO₂/orthorhombic CaTiO₃/cubic CdO/tetragonal TiO₂/C nanocomposite material includes calcining metal precursors.

### BACKGROUND

### Technical Field

The present disclosure is directed towards nanocomposite materials, and more particularly, relates to a composition of materials used to fabricate a nanocomposite and a method of production thereof.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Presently, advanced nanocomposite materials are of utmost importance in various industrial applications, including, but are not limited to, catalysis, energy storage, and electronic devices. Advanced nanocomposites possess a high surface area, tunable porosity, enhanced mechanical strength, and enhanced thermal and chemical stability, which renders the nanocomposites to be desirable for the aforementioned applications. Further, an ability of the nanocomposites to exhibit unique electrical, optical, and catalytic properties due to controlled nanoscale interactions further increases utility of the nanocomposite across various fields of application. However, existing nanocomposites may exhibit limitations in achieving a balance between structural stability, high porosity, and multi-functionality. Titanium oxide-based materials, in particular, have been widely researched for their potential in the aforementioned applications, yet challenges persist in integrating multiple crystalline phases while maintaining precise control over morphology and crystallite size.

Current solutions in the field primarily focus on single-phase materials or binary composites, which restrict the ability of the solutions to provide enhanced structural and functional properties. Various synthesis techniques, such as hydrothermal, sol-gel, and solid-state reactions, have been employed to develop titanium oxide-based composites. Despite these efforts, the resulting materials frequently suffer from non-uniform phase distribution, uncontrolled particle size, and inadequate porosity, reducing performance of the nanocomposites in applications requiring high surface area and stability.

The limitations of the existing materials highlight a requirement for a new approach to nanocomposite synthesis. Many traditional fabrication techniques require high temperatures or complex processing steps, leading to increased production costs and energy consumption. Furthermore, single-phase and binary materials often lack the ability to simultaneously achieve high crystallinity, controlled morphology, and optimized porosity. The above listed factors create a demand for a nanocomposite that overcomes the challenges explained herein, while offering improved performance across multiple fields of application.

Accordingly, one object of the present disclosure is to provide a multiphase nanocomposite material, and a method of synthesis thereof, that may circumvent the drawbacks and limitations, such as, high energy consumption, lengthy processing times, costly precursors, agglomeration, and scalability issues, of existing materials and methods known in the art.

### SUMMARY

In an exemplary embodiment, an orthorhombic TiO₂/orthorhombic CaTiO₃/cubic CdO/tetragonal TiO₂/C nanocomposite material includes an orthorhombic titanium dioxide (TiO₂) phase, an orthorhombic calcium titanate (CaTiO₃) phase, a cubic cadmium oxide (CdO) phase, and a tetragonal TiO₂ phase. The orthorhombic TiO₂/orthorhombic CaTiO₃/cubic CdO/tetragonal TiO₂/C nanocomposite material has a porous, granular morphology including spherical particles having an average particle diameter in a range from 10 nanometer (nm) to 140 nm.

In some embodiments, the spherical particles have an average particle diameter in a range from 30 nm to 90 nm.

In some embodiments, the spherical particles have an average particle diameter in a range from 50 nm to 70 nm.

In some embodiments, the orthorhombic TiO₂/orthorhombic CaTiO₃/cubic CdO/tetragonal TiO₂/C nanocomposite material has an oxygen content in a range from 40 atomic % (at. %) to 70 at. %, a titanium content in a range from 10 at. % to 30 at. %, a calcium content in a range from 10 at. % to 20 at. %, a carbon content in a range from 5 at. % to 15 at. %, and a cadmium content in a range from 0.5 at. % to 5 at. % based on a total number of atoms in the orthorhombic TiO₂/orthorhombic CaTiO₃/cubic CdO/tetragonal TiO₂/C nanocomposite material.

In some embodiments, the orthorhombic TiO₂/orthorhombic CaTiO₃/cubic CdO/tetragonal TiO₂/C nanocomposite material has an oxygen content in a range from 45 at. % to 65 at. %, a titanium content in a range from 13 at. % to 27 at. %, a calcium content in a range from 12 at. % to 18 at. %, a carbon content in a range from 6 at. % to 12 at. %, and a cadmium content in a range from 1 at. % to 3 at. % based on a total number of atoms in the orthorhombic TiO₂/orthorhombic CaTiO₃/cubic CdO/tetragonal TiO₂/C nanocomposite material.

In some embodiments, the orthorhombic TiO₂/orthorhombic CaTiO₃/cubic CdO/tetragonal TiO₂/C nanocomposite material has an oxygen content in a range from 50 at. % to 60 at. %, a titanium content in a range from 17 at. % to 23 at. %, a calcium content in a range from 13 at. % to 17 at. %, a carbon content in a range from 7 at. % to 10 at. %, and a cadmium content in a range from 1.5 at. % to 2.7 at. % based on a total number of atoms in the orthorhombic TiO₂/orthorhombic CaTiO₃/cubic CdO/tetragonal TiO₂/C nanocomposite material.

In some embodiments, the orthorhombic TiO₂/orthorhombic CaTiO₃/cubic CdO/tetragonal TiO₂/C nanocomposite material has an average crystallite size in a range from 60 nm to 90 nm.

In some embodiments, the orthorhombic TiO₂/orthorhombic CaTiO₃/cubic CdO/tetragonal TiO₂/C nanocomposite material has an average crystallite size in a range from 65 nm to 85 nm.

In some embodiments, the orthorhombic TiO₂/orthorhombic CaTiO₃/cubic CdO/tetragonal TiO₂/C nanocomposite material has an average crystallite size in a range from 70 nm to 80 nm.

In another exemplary embodiment, a method of producing the orthorhombic TiO₂/orthorhombic CaTiO₃/cubic CdO/tetragonal TiO₂/C nanocomposite material includes adding a first solution including titanium butoxide, ethanol, and acetic acid stepwise to a second solution including calcium nitrate tetrahydrate (Ca(NO₃)₂·6H₂O) and cadmium nitrate tetrahydrate (Cd(NO₃)₂·4H₂O) under stirring to form a reaction mixture. Further, the method includes adding a third solution including galactose, stepwise to the reaction mixture under stirring at 200° C., stirring the reaction mixture at 200° C. until a solid is formed, and calcining the solid at a temperature in a range from 600° C. to 800° C. for 1 hour to 5 hours to yield the orthorhombic TiO₂/orthorhombic CaTiO₃/cubic CdO/tetragonal TiO₂/C nanocomposite material.

In some embodiments, the concentration of titanium butoxide in the first solution is in a range from 100 milliliters per liter (ml/L) to 300 ml/L.

In some embodiments, the concentration of titanium butoxide in the first solution is 200 ml/L.

In some embodiments, the concentration of ethanol in the first solution is in a range from 100 ml/L to 300 ml/L.

In some embodiments, the concentration of Ca(NO₃)₂·6H₂O in the second solution is in a range from 80 grams per liter (g/L) to 100 g/L.

In some embodiments, the concentration of Cd(NO₃)₂·4H₂O in the second solution is in a range from 100 g/L to 130 g/L.

In some embodiments, the concentration of galactose in the third solution is in a range from 50 g/L to 75 g/L.

In some embodiments, the solid is calcined at a temperature in a range from 650° C. to 750° C.

In some embodiments, the solid is calcined at 700° C.

In some embodiments, the solid is calcined for 2 hours to 4 hours.

In some embodiments, the solid is calcined for 3 hours.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary flow chart for a method of producing orthorhombic TiO₂/orthorhombic CaTiO₃/Cubic CdO/Tetragonal TiO₂/C nanocomposite material, according to certain embodiments.

FIG. 1B illustrates an exemplary block diagram depicting the method of producing the orthorhombic TiO₂/orthorhombic CaTiO₃/Cubic CdO/Tetragonal TiO₂/C nanocomposite material, according to certain embodiments.

FIG. 2 is a graph depicting X-ray diffraction (XRD) pattern of the orthorhombic TiO₂/orthorhombic CaTiO₃/Cubic CdO/Tetragonal TiO₂/C nanocomposite material, according to certain embodiments.

FIG. 3 is a graph depicting a distribution of atomic percentages of elements in the orthorhombic TiO₂/orthorhombic CaTiO₃/Cubic CdO/Tetragonal TiO₂/C nanocomposite material, as determined by energy dispersive X-ray spectroscopy (EDX), according to certain embodiments.

FIG. 4 shows a scanning electron microscope (SEM) image of the orthorhombic TiO₂/orthorhombic CaTiO₃/Cubic CdO/Tetragonal TiO₂/C nanocomposite material, at a magnification of 5 micrometer (μm), according to certain embodiments.

FIG. 5 shows high-resolution transmission electron microscope (HRTEM) image of the orthorhombic TiO₂/orthorhombic CaTiO₃/Cubic CdO/Tetragonal TiO₂/C nanocomposite material, at a magnification of 200 nanometer (nm), according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words ‘a,’ ‘an’ and the like generally carry a meaning of ‘one or more,’ unless stated otherwise.

Furthermore, the terms ‘approximately,’ ‘approximate,’ ‘about,’ and similar terms generally refer to ranges that include the identified value within a margin of 20%, 10%, or preferably 5%, and any values therebetween.

As used herein, the term ‘room temperature’ refers to a temperature range of ‘25 degrees Celsius (° C.)±3° C. in the present disclosure.

As used herein, the term ‘nanoparticles (NPs)’ refers to particles having a particle size of 1 nanometer (nm) to 500 nm within the scope of the present disclosure.

As used herein, the term ‘nanocomposite’ refers to a composite material that has at least one component with a grain size measured in nanometers.

As used herein, the term ‘nanohybrid composite’ refers to a material that combines nanomaterials (such as nanoparticles, nanotubes, or nanofibers) with another material, typically a polymer, metal, or ceramic, to form a composite structure. The nanomaterials are typically incorporated at the nanoscale level to enhance the properties of the base material, such as improving strength, conductivity, or flexibility, while maintaining the advantages of both components. The resulting nanohybrid composite exhibits unique properties that are enhanced to the individual materials alone.

As used herein, the term ‘porosity’ refers to a measure of the void or vacant spaces within a material.

As used herein, the term ‘pore diameter’ refers to an average width or size of the pores (void spaces) within a material, typically measured in nm or angstroms (Å). It is a parameter in characterizing the texture and permeability of porous materials, influencing their adsorption, filtration, or catalytic properties. The pore diameter is often determined using methods such as nitrogen adsorption or mercury intrusion, which provide insights into the material's ability to absorb or interact with molecules of specific sizes.

As used herein, the term ‘pore volume’ refers to the total volume of void spaces (pores) within a material that is capable of being filled by a gas or liquid. It is typically expressed in cubic centimeters per gram (cm³/g) and is a parameter in characterizing the porous structure of materials, such as adsorbents or catalysts.

As used herein, the term ‘average particle size’ refers to the mean diameter of nanoparticles in a sample, typically calculated from measurements obtained using techniques such as scanning electron microscopy (SEM) or transmission electron microscopy (TEM), representing the typical size of the particles in the distribution.

As used herein, the term ‘average crystallite size’ refers to the mean size of crystalline regions in a material, typically determined through X-ray diffraction (XRD) analysis, and represents the size of the individual crystal domains within the sample, excluding any amorphous material.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

An aspect of the present disclosure is directed to an orthorhombic TiO₂/orthorhombic CaTiO₃/cubic CdO/tetragonal TiO₂/C nanocomposite (also referred to as a nanocomposite material) fabricated via a precise sol-gel/combustion approach. The nanocomposite material fabricated by the method of the present disclosure achieves a multi-phase crystalline structure with controlled morphology and enhanced properties for advanced material applications.

A nanocomposite material includes an orthorhombic TiO₂ phase, an orthorhombic CaTiO₃ phase, a cubic CdO phase, and a tetragonal TiO₂ phase. In some embodiments, the nanocomposite material may include crystalline phases, but is not limited to quartz, calcite, hematite, magnetite, goethite, dolomite, albite, anorthite, pyrite, fluorite, halite, barite, apatite, rutile, and zircon.

In some embodiments, the nanocomposite material may have an average crystallite size in a range from 50 to 100 nm, preferably 60 to 90 nm, preferably 65 to 85 nm, preferably 70 to 80 nm, preferably 75 to 80 nm. In a preferred embodiment, the nanocomposite material has an average crystallite size of 76.01 nm.

In some embodiments, the nanocomposite material is porous. Pores may be micropores, mesopores, macropores, and/or a combination thereof. The pores exist in the bulk material, not necessarily in the molecular structure of the material. The term ‘microporous’ means that nanocomposite have pores with an average pore width (i.e. diameter) of less than 2 nm. The term ‘mesoporous’ means the pores of the nanocomposite have an average pore width of 2-50 nm. The term ‘macroporous’ means the pores of nanocomposite have an average pore width larger than 50 nm. Pore size may be determined by methods including, but not limited to, gas adsorption (e.g. N₂ adsorption), mercury intrusion porosimetry, and imaging techniques such as scanning electron microscopy (SEM), and X-ray computed tomography (XRCT).

In some embodiments, the nanocomposite material comprises sheet morphologies, preferably nanosheets, although other morphologies such as nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, and their mixtures thereof are also possible. In a preferred embodiment, the nanocomposite material has a porous, granular morphology that includes spherical particles. In some embodiments, the spherical particles may have an average particle diameter ranging from 5 to 160 nm, preferably 10 to 140 nm, preferably 30 to 90 nm, preferably 50 to 70 nm, preferably 55 to 65 nm. In a preferred embodiment, the spherical particles have an average particle diameter of 60.42 nm.

In some embodiments, the nanocomposite material has an oxygen content in a range from 30 to 80 atomic % (at. %), 40 to 70 atomic % (at. %), preferably 45 to 65 atomic % (at. %), preferably 50 to 60 atomic % (at. %), preferably 55 to 60 atomic % (at. %) based on a total number of atoms in the nanocomposite material. In a preferred embodiment, the nanocomposite material has an oxygen content of 54.5% based on the total number of atoms in the nanocomposite material.

In some embodiments, the nanocomposite material has a titanium content in a range from 5 to 40 at. %, preferably 10 to 30 at. %, preferably 13 to 27 at. %, preferably 17 to 23 at. %, preferably 18 to 20 at. % based on the total number of atoms in the nanocomposite material. In a preferred embodiment, the nanocomposite material has a titanium content of 20.2% based on the total number of atoms in the nanocomposite material.

In some embodiment, the nanocomposite material has a calcium content ranging from 5 to 25 at. %, preferably 10 to 20 at. %, preferably 12 to 18 at. %, preferably 13 to 17 at. %, preferably 15 to 16 at. % based on the total number of atoms in the nanocomposite material. In a preferred embodiment, the nanocomposite has a calcium content of 14.9% based on the total number of atoms in the nanocomposite material.

In some embodiment, the nanocomposite material has a carbon content in a range from 2.5 to 20 at. %, preferably 5 to 15 at. %, preferably 6 to 12 at. %, preferably 7 to 10 at. %, preferably 6 to 8 at. % based on the total number of atoms in the nanocomposite material. In a preferred embodiment, the nanocomposite has a carbon content of 8.2% based on the total number of atoms in the nanocomposite material.

In some embodiments, the nanocomposite material has a cadmium content in a range from 0.25 to 10 at. % preferably 0.5 to 5 at. %, preferably 1 to 3 at. %, preferably 1.5 to 2.7 at. % based on the total number of atoms in the nanocomposite material. In a preferred embodiment, the nanocomposite has a cadmium content of 2.2% based on the total number of atoms in the nanocomposite material.

In one or more embodiments, the nanocomposite material has an orthorhombic TiO₂ content in a range from 5 to 20 wt. %, an orthorhombic CaTiO₃ in a range from 55 to 85 wt. %, a cubic CdO content in a range from 1 to 10 wt. %, a tetragonal TiO₂ content in a range from 1 to 10 wt. %, and a C content in a range from 1 to 15 wt. %, based on the total weight of the nanocomposite material.

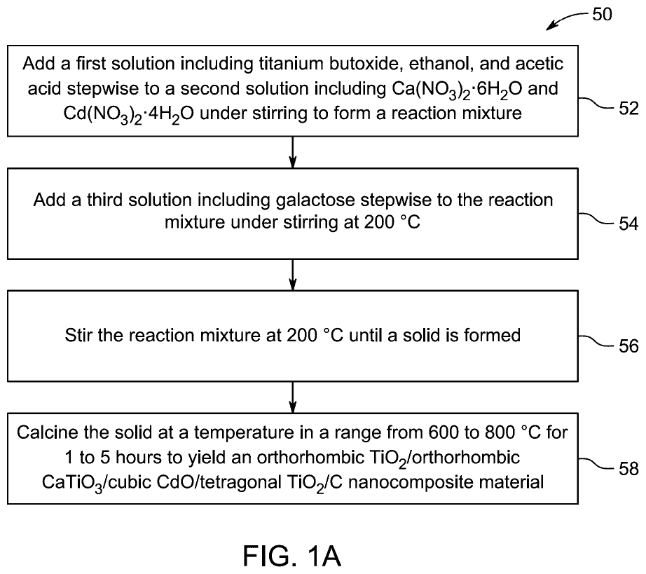

FIG. 1A illustrates a schematic flow chart of a method 50 of preparing the orthorhombic TiO₂/orthorhombic CaTiO₃/cubic CdO/tetragonal TiO₂/C nanocomposite material. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes adding a first solution including titanium butoxide, ethanol, and acetic acid stepwise to a second solution including Ca(NO₃)₂·6H₂O and Cd(NO₃)₂·4H₂O under stirring to form a reaction mixture. In some embodiments, other sources of titanium such as titanium chloride, titanium sulfate, titanium oxalate, titanium citrate, titanium fluoride, titanium bromide, titanium iodide, titanium acetate, titanium lactate, titanium tartrate, titanium perchlorate, titanium phosphate, titanium arsenate, titanium tungstate, titanium molybdate, titanium formate, titanium carbonate, titanium borate, titanium silicate, titanium selenate, titanium tellurate, titanium vanadate, titanium chromate, titanium ferrate, titanium manganate, titanium stannate, titanium zirconate, titanium niobate, titanium tantalate, titanium hydroxide, and/or combinations thereof, may also be used instead of titanium butoxide. In some embodiments, the concentration of titanium butoxide in the first solution may range from 50 to 400 ml/L, preferably 100 to 300 ml/L, preferably 150 to 300 ml/L, preferably 200 to 300 ml/L, preferably 250 to 300 ml/L. In a preferred embodiment, the concentration of titanium butoxide in the first solution is 200 ml/L.

Although it is preferred to use Ca(NO₃)₂·6H₂O as the calcium salt, in some embodiments, other sources of the calcium salt, may also be used, including, but not limited to, calcium chloride, calcium sulfate, calcium carbonate, calcium acetate, calcium citrate, calcium phosphate, calcium lactate, calcium oxalate, calcium tartrate, calcium formate, calcium silicate, calcium fluoride, calcium bromide, calcium iodide, calcium arsenate, calcium molybdate, calcium tungstate, calcium chromate, calcium permanganate, calcium borate, calcium selenate, calcium tellurate, calcium vanadate, calcium ferrate, calcium stannate, calcium zirconate, calcium hydroxide, calcium hypochlorite, calcium thiocyanate, and calcium thiophosphate. In some embodiment, the concentration of Ca(NO₃)₂·6H₂O in the second solution may range from 50 to 150 g/L, preferably 80 to 100 g/L, preferably 82 to 100 g/L, preferably 85 to 100 g/L, preferably 90 to 100 g/L, preferably 92 to 100 g/L, preferably 95 to 100 g/L. In a preferred embodiment, the concentration of Ca(NO₃)₂·6H₂O in the second solution is 91 g/L.

In some embodiments, the cadmium salt may include but is not limited to cadmium chloride, cadmium sulfate, cadmium acetate, cadmium carbonate, cadmium phosphate, cadmium fluoride, cadmium bromide, cadmium iodide, cadmium oxalate, cadmium citrate, cadmium formate, cadmium lactate, cadmium tartrate, cadmium arsenate, cadmium molybdate, cadmium tungstate, cadmium chromate, cadmium permanganate, cadmium borate, cadmium selenate, cadmium tellurate, cadmium vanadate, cadmium ferrate, cadmium manganate, cadmium stannate, cadmium zirconate, cadmium hydroxide, cadmium thiocyanate, and cadmium thiophosphate. In a preferred embodiment, cadmium salt is Cd(NO₃)₂·4H₂O. In some embodiment, the concentration of Cd(NO₃)₂·4H₂O in the second solution may range from 50 to 150 g/L, preferably 100 to 130 g/L, preferably 105 to 130 g/L, preferably 110 to 130 g/L, preferably 115 to 130 g/L, preferably 120 to 130 g/L, preferably 125 to 130 g/L. In a preferred embodiment, the concentration of Cd(NO₃)₂·4H₂O in the second solution is 120 g/L.

In some embodiments, the concentration of ethanol in the first solution may range from 50 to 400 ml/L, preferably 100 to 300 ml/L, preferably 150 to 300 ml/L, preferably 200 to 300 ml/L, preferably 250 to 300 ml/L. In a preferred embodiment, the concentration of ethanol in the first solution is 200 ml/L.

At step 54, the method 50 includes adding a third solution including galactose stepwise to the reaction mixture under stirring at 200° C. In some embodiments, other sugars, apart from galactose, such as fructose, mannose, ribose, xylose, arabinose, rhamnose, allose, altrose, gulose, idose, talose, sorbose, tagatose, psicose, lactose, maltose, sucrose, trehalose, raffinose, melezitose, cellobiose, fucose, deoxyribose, glucuronic acid, gluconic acid, xylohexose, ribopyranose, arabinopyranose, mannopyranose, and/or combinations thereof may also be used. In some embodiments, the galactose concentration may range from 20 to 150 g/L, preferably 50 to 75 g/L, preferably 55 to 75 g/L, preferably 60 to 75 g/L, preferably 65 to 75 g/L, preferably 70 to 75 g/L. In a preferred embodiment, the concentration of galactose is 65 g/L.

At step 56, the method 50 includes stirring the reaction mixture at 200° C. until a solid is formed.

At step 58, the method 50 includes calcining the solid at a temperature in a range from 600 to 800° C. for 1 to 5 h to yield the orthorhombic TiO₂/orthorhombic CaTiO₃/cubic CdO/tetragonal TiO₂/C nanocomposite material. In some embodiments, the solid is calcined at a temperature in a range from 650 to 750° C., preferably 670 to 750° C., preferably 700 to 750° C., preferably 725 to 750° C. In a preferred embodiment, the solid is calcined at 700° C. In some embodiment, the solid is calcined for 2 to 4 hours, preferably 2.5 to 4 hours, preferably 3 to 4 hours, preferably 3.5 to 4 hours, and preferably 3.75 to 4 hours. In a preferred embodiment, the solid is calcined for 3 hours.

### EXAMPLES

The following examples demonstrate a nanocomposite material and a method of production thereof. The examples are provided solely for illustration and are not to be construed as limitations of the present disclosure, as many variations thereof are possible without departing from the spirit and scope of the present disclosure.

### Example 1: Synthesis of Orthorhombic TiO₂/Orthorhombic CaTiO₃/Cubic CdO/Tetragonal TiO₂/C Nanocomposite

According to the present disclosure, the orthorhombic TiO₂/orthorhombic CaTiO₃/cubic CdO/tetragonal TiO₂/C nanocomposite was synthesized using a sol-gel/combustion method, as described in FIG. 1B. In particular, the method included dissolving 45 milliliters (mL) of titanium butoxide (TiOBu₄) in a mixture including 45 mL of ethanol (CH₃CH₂OH) and 135 mL of glacial acetic acid (CH₃CO₂H). Further, 10.46 grams (g) of calcium nitrate hexahydrate (Ca(NO₃)₂·6H₂O) and 13.66 g of cadmium nitrate tetrahydrate (Cd(NO₃)₂·4H₂O) were dissolved in 115 mL of distilled water (DW) and gradually introduced into the titanium butoxide solution under continuous stirring for 15 minutes. Subsequently, 7.31 g of galactose was dissolved in 115 mL of distilled water and slowly added to the mixture with continuous stirring at 200° C. until complete solvent evaporation. The resultant powder was then dried and calcined at 700° C. for 3 hours to produce the orthorhombic TiO₂/orthorhombic CaTiO₃/cubic CdO/tetragonal TiO₂/C nanocomposite.

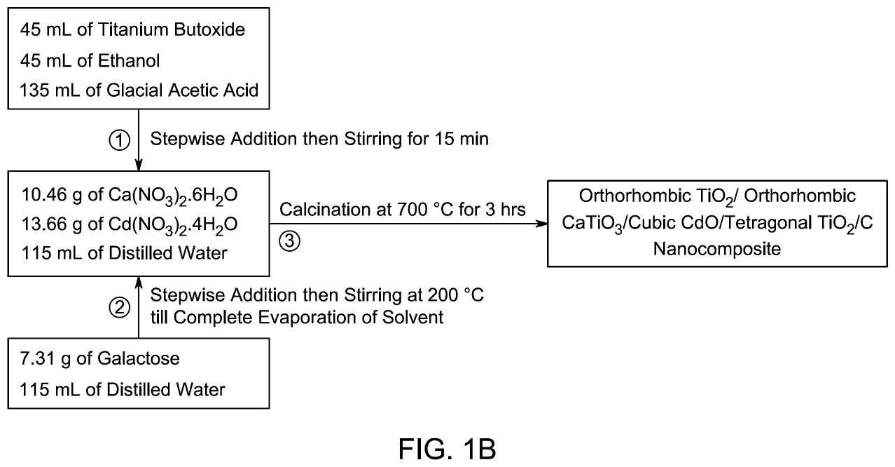

X-ray diffraction (XRD) patterns for the synthesized nanocomposite are shown in FIG. 2. In particular, FIG. 2 depicts the presence of multiple crystalline phases including orthorhombic TiO₂, orthorhombic CaTiO₃, cubic CdO, and tetragonal TiO₂, as listed in Table 1. The orthorhombic TiO₂ phase was identified using a JCPDS card number 01-071-4943, which showed diffraction peaks at 2θ° values of 25.59°, 29.48°, 31.15°, 36.29°, 39.14°, and 54.35°, corresponding to the Miller indices (111), (211), (020), (102), (400), and (230), respectively. The orthorhombic CaTiO₃ phase, identified using card number JCPDS (No. 01-042-0423), exhibited peaks at 2θ° values of 23.40°, 27.38°, 33.16°, 40.91°, 42.59°, 44.38°, 47.73°, 52.04°, 59.28°, 73.23°, 74.29°, and 79.32°. The corresponding diffractions originated from the orthorhombic CaTiO₃ planes with respective Miller indices (101), (111), (121), (022), (131), (122), (040), (231), (042), (152), (341), and (204). Further, the peaks for cubic CdO phase originated from 2θ° values of 38.39°, 55.39°, 56.99°, and 69.57°, identified with card number JCPDS (No. 01-080-4041) with corresponding Miller indices (200), (220), (311), and (222), respectively. The tetragonal TiO₂ phase, identified with JCPDS (No. 01-078-2486), exhibited peaks at 2θ° values of 62.85° and 75.24°, corresponding to the Miller indices (204) and (215), respectively. The synthesized nanocomposite exhibited an average crystallite size of 76.01 nm.

TABLE 1
Structural and crystallographic properties of the synthesized
nanocomposite components, as determined by XRD.

| | | | | Average crystallite |
|---|---|---|---|---|
| Components of synthesized nanocomposite | | | | size of synthesized |
| Phase | Chemical name | Card No. | Crystal system | nanocomposite (nm) |
| TiO₂ | Titanium oxide | JCPDS-01-071-4943 | Orthorhombic | 76.01 |
| CaTiO₃ | Calcium titanate | JCPDS-00-042-0423 | Orthorhombic | |
| CdO | Cadmium oxide | JCPDS-01-080-4041 | Cubic | |
| TiO₂ | Titanium oxide | JCPDS-01-078-2486 | Tetragonal | |

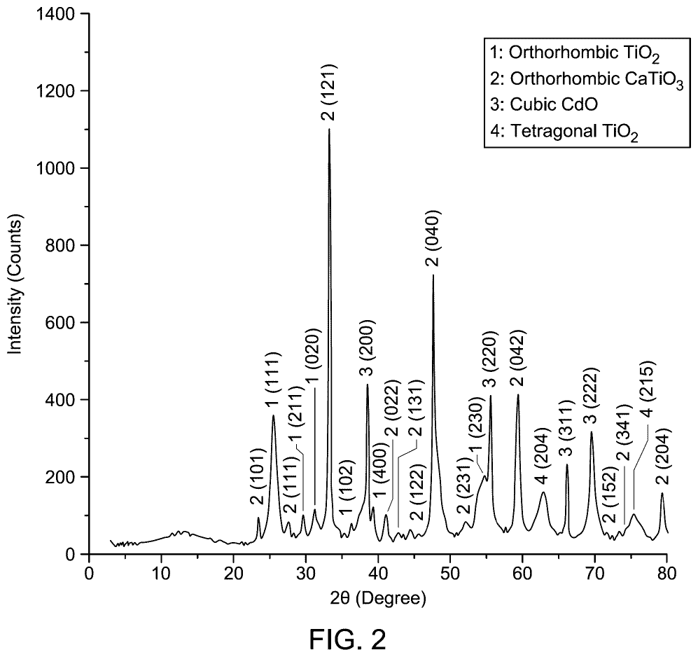

Further, FIG. 3 illustrates the elemental distribution of the synthesized nanocomposite as determined by energy dispersive X-ray spectroscopy (EDX). The atomic percentages of the elements were determined as 54.5 atomic percent (at. %) oxygen (O), 20.2 at. % titanium (Ti), 14.9 at. % calcium (Ca), 8.2 at. % carbon (C), and 2.2 at. % cadmium (Cd). The presence of carbon was attributed to the synthesis of the nanocomposite via the sol-gel/combustion method, where galactose was used as a fuel. During the combustion process, galactose contributed to the carbon content observed in the sample. The aforementioned elemental analysis confirmed the successful incorporation of the desired elements into the nanocomposite while also accounting for the residual carbon originating from the organic fuel.

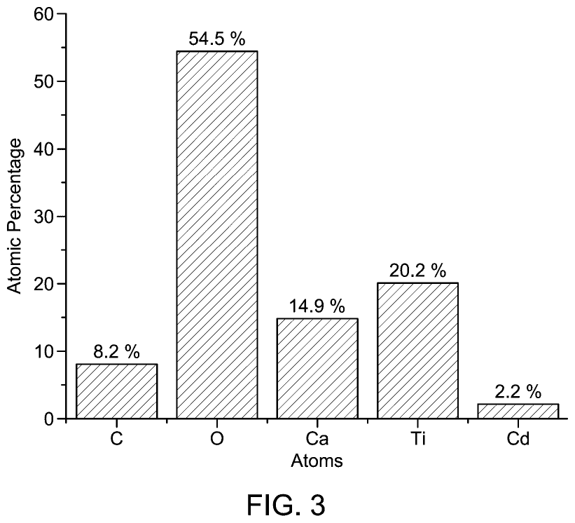

The scanning electron microscope (SEM) image of the synthesized nanocomposite, revealed the porous morphology with a heterogeneous distribution of particles, as shown in FIG. 4. In particular, FIG. 4 depicts irregularly shaped voids and cavities, indicative of a highly porous structure. In addition, spherical and agglomerated particles were visible on the surface, suggesting the formation of nanoparticles within the composite matrix. The interconnected porous framework and the presence of well-defined spherical nanoparticles highlight the potential of the material for applications requiring high surface area and active sites, such as adsorption or catalysis. The obtained structural observation aligned with the designed synthesis process to achieve a composite with enhanced functionality.

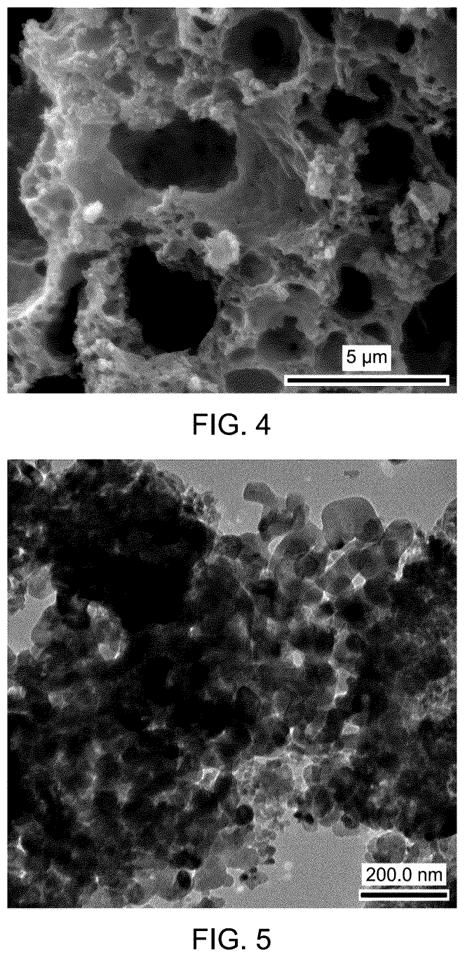

A high-resolution transmission electron microscope (HRTEM) image of the synthesized nanocomposite is depicted in FIG. 5. The obtained image identified the nanoscale morphology. In particular, FIG. 5 shows a mixture of spherical and irregularly shaped particles with a uniform distribution throughout the composite matrix. The particles were densely packed and exhibited clear edges, suggesting the formation of well-defined nanostructures. The average particle diameter was confirmed to be 60.42 nm, indicating a successful synthesis of nanoparticles within the desired size range. The spherical morphology and uniform particle size indicates the synthesized nanocomposite may be useful in applications requiring high surface area and reactivity.

The aspects of the present disclosure provides the orthorhombic TiO₂/orthorhombic CaTiO₃/cubic CdO/tetragonal TiO₂/C nanocomposite synthesized through a sol-gel/combustion method. The nanocomposite as described herein, was distinguished by distinctive multi-phase crystalline structure and desirable properties. XRD confirmed the presence of orthorhombic TiO₂, orthorhombic CaTiO₃, cubic CdO, and tetragonal TiO₂ phases, with an average crystallite size of 76.01 nm. SEM revealed a porous morphology characterized by irregular voids and spherical particles, highlighting the high surface area and structural uniformity. EDX spectroscopy showed the elemental composition as 54.5% oxygen (O), 20.2% titanium (Ti), 14.9% calcium (Ca), 8.2% carbon (C), and 2.2% cadmium (Cd), with the carbon content originating from galactose used as a fuel during synthesis. HR-TEM showed spherical and irregular nanoparticles with a uniform distribution and an average particle diameter of 60.42 nm, further emphasizing the nanoscale precision of the nanocomposite. Hence, nanocomposite overcomes existing challenges by integrating multiple crystalline phases, achieving controlled morphology and functionality, and providing potential for industrial applications in advanced material science. Hence, the present disclosure may address the limitations of existing technologies by the orthorhombic TiO₂/orthorhombic CaTiO₃/cubic CdO/tetragonal TiO₂/C nanocomposite synthesized using the sol-gel/combustion method. The synthesized nanocomposite may overcome certain existing limitation by achieving a combination of multiple crystalline phases with an average crystallite size of 76.01 nm and a highly porous structure, as confirmed by XRD, SEM, and TEM analyses. The incorporation of spherical and irregular nanoparticles within a porous framework provides a uniform distribution and enhanced surface area, making it suitable for a wide range of advanced applications. Moreover, the use of galactose as fuel during the combustion process allowed for a controlled synthesis pathway while introducing residual carbon to further improve the functionality of the nanocomposite material. In one or more embodiments, the Brunauer-Emmett-Teller (BET) surface area, total pore volume, and average pore diameter of the nanocomposite, as determined using an N₂ adsorption/desorption analyzer, measured 67.92 m²/g, 0.1254 cm³/g, and 3.35 nm, respectively, highlighting the desirable porosity properties of the orthorhombic TiO₂/orthorhombic CaTiO₃/cubic CdO/tetragonal TiO₂/C nanocomposite.

The synthesized nanocomposite may be utilized in water treatment technologies for efficient removal of heavy metals and organic pollutants due to its multi-phase crystalline structure. Further, the prepared nanocomposite has potential applications in catalysis for industrial chemical processes, benefiting from a uniform morphology of the nanocomposite and active surface sites. In addition, the nanocomposite material may be applied in advanced sensing devices due to the desirable nanoscale properties and electrical characteristics of the nanocomposite for environmental and biomedical monitoring.

Numerous modifications and variations of the present disclosure are possible in light of the above teachings. It is, therefore, to be understood that within the scope of the appended claims, the disclosure may be practiced otherwise than as specifically described herein.

1. An orthorhombic TiO₂/orthorhombic CaTiO₃/cubic CdO/tetragonal TiO₂/C nanocomposite material, comprising:
an orthorhombic TiO₂ phase;
an orthorhombic CaTiO₃ phase;
a cubic CdO phase; and
a tetragonal TiO₂ phase,
wherein the orthorhombic TiO₂/orthorhombic CaTiO₃/cubic CdO/tetragonal TiO₂/C nanocomposite material has a porous, granular morphology comprising spherical particles having an average particle diameter in a range from 10 to 140 nm.

2. The orthorhombic TiO₂/orthorhombic CaTiO₃/cubic CdO/tetragonal TiO₂/C nanocomposite material of claim 1, wherein the spherical particles have an average particle diameter in a range from 30 to 90 nm.

3. The orthorhombic TiO₂/orthorhombic CaTiO₃/cubic CdO/tetragonal TiO₂/C nanocomposite material of claim 2, wherein the spherical particles have an average particle diameter in a range from 50 to 70 nm.

4. The orthorhombic TiO₂/orthorhombic CaTiO₃/cubic CdO/tetragonal TiO₂/C nanocomposite material of claim 1, wherein the orthorhombic TiO₂/orthorhombic CaTiO₃/cubic CdO/tetragonal TiO₂/C nanocomposite material has an oxygen content in a range from 40 to 70 atomic % (at. %), a titanium content in a range from 10 to 30 at. %, a calcium content in a range from 10 to 20 at. %, a carbon content in a range from 5 to 15 at. %, and a cadmium content in a range from 0.5 to 5 at. % based on a total number of atoms in the orthorhombic TiO₂/orthorhombic CaTiO₃/cubic CdO/tetragonal TiO₂/C nanocomposite material.

5. The orthorhombic TiO₂/orthorhombic CaTiO₃/cubic CdO/tetragonal TiO₂/C nanocomposite material of claim 4, wherein the orthorhombic TiO₂/orthorhombic CaTiO₃/cubic CdO/tetragonal TiO₂/C nanocomposite material has an oxygen content in a range from 45 to 65 atomic % (at. %), a titanium content in a range from 13 to 27 at. %, a calcium content in a range from 12 to 18 at. %, a carbon content in a range from 6 to 12 at. %, and a cadmium content in a range from 1 to 3 at. % based on a total number of atoms in the orthorhombic TiO₂/orthorhombic CaTiO₃/cubic CdO/tetragonal TiO₂/C nanocomposite material.

6. The orthorhombic TiO₂/orthorhombic CaTiO₃/cubic CdO/tetragonal TiO₂/C nanocomposite material of claim 5, wherein the orthorhombic TiO₂/orthorhombic CaTiO₃/cubic CdO/tetragonal TiO₂/C nanocomposite material has an oxygen content in a range from 50 to 60 atomic % (at. %), a titanium content in a range from 17 to 23 at. %, a calcium content in a range from 13 to 17 at. %, a carbon content in a range from 7 to 10 at. %, and a cadmium content in a range from 1.5 to 2.7 at. % based on a total number of atoms in the orthorhombic TiO₂/orthorhombic CaTiO₃/cubic CdO/tetragonal TiO₂/C nanocomposite material.

7. The orthorhombic TiO₂/orthorhombic CaTiO₃/cubic CdO/tetragonal TiO₂/C nanocomposite material of claim 1, wherein the orthorhombic TiO₂/orthorhombic CaTiO₃/cubic CdO/tetragonal TiO₂/C nanocomposite material has an average crystallite size in a range from 60 to 90 nm.

8. The orthorhombic TiO₂/orthorhombic CaTiO₃/cubic CdO/tetragonal TiO₂/C nanocomposite material of claim 7, wherein the orthorhombic TiO₂/orthorhombic CaTiO₃/cubic CdO/tetragonal TiO₂/C nanocomposite material has an average crystallite size in a range from 65 to 85 nm.

9. The orthorhombic TiO₂/orthorhombic CaTiO₃/cubic CdO/tetragonal TiO₂/C nanocomposite material of claim 8, wherein the orthorhombic TiO₂/orthorhombic CaTiO₃/cubic CdO/tetragonal TiO₂/C nanocomposite material has an average crystallite size in a range from 70 to 80 nm.

10. A method of producing the orthorhombic TiO₂/orthorhombic CaTiO₃/cubic CdO/tetragonal TiO₂/C nanocomposite material of claim 1, comprising:
adding a first solution comprising titanium butoxide, ethanol, and acetic acid stepwise to a second solution comprising Ca(NO₃)₂·6H₂O and Cd(NO₃)₂·4H₂O under stirring to form a reaction mixture;
adding a third solution comprising galactose stepwise to the reaction mixture under stirring at 200° C.;
stirring the reaction mixture at 200° C. until a solid is formed; and
calcining the solid at a temperature in a range from 600° C. to 800° C. for 1 to 5 hr to yield the orthorhombic TiO₂/orthorhombic CaTiO₃/cubic CdO/tetragonal TiO₂/C nanocomposite material.

11. The method of claim 10, wherein the concentration of titanium butoxide in the first solution is in a range from 100 to 300 ml/L.

12. The method of claim 11, wherein the concentration of titanium butoxide in the first solution is 200 ml/L.

13. The method of claim 10, wherein the concentration of ethanol in the first solution is in a range from 100 to 300 ml/L.

14. The method of claim 10, wherein the concentration of Ca(NO₃)₂·6H₂O in the second solution is in a range from 80 to 100 g/L.

15. The method of claim 10, wherein the concentration of Cd(NO₃)₂·4H₂O in the second solution is in a range from 100 to 130 g/L.

16. The method of claim 10, wherein the concentration of galactose in the third solution is in a range from 50 to 75 g/L.

17. The method of claim 10, wherein the solid is calcined at a temperature in a range from 650 to 750° C.

18. The method of claim 17, wherein the solid is calcined at 700° C.

19. The method of claim 10, wherein the solid is calcined for 2 to 4 hours.

20. The method of claim 10, wherein the solid is calcined for 3 hours.
